(19) United States
(12) Patent Application Publication
(10) Pub. No.: US 2011/0001626 A1
(43) Pub. Date: Jan. 6, 2011

(54) APPARATUS AND SYSTEM FOR LED STREET LAMP MONITORING AND CONTROL

(75) Inventors: Chak Lam Peter Yip, Hong Kong (CN); King Chung Vamco Tsoi, Hong Kong (CN)

Correspondence Address: EAGLE IP LIMITED, 13/F, Bright Way Tower, 33 Mong Kok Road, Kowloon, HK

(73) Assignee: TRI-CONCEPT TECHNOLOGY LIMITED, Hong Kong (CN)

(21) Appl. No.: 12/918,818

(22) PCT Filed: Feb. 23, 2009
(86) PCT No.: PCT/CN09/70504

§ 371 Date: Aug. 22, 2010

Related U.S. Application Data
(60) Provisional application No. 61/030,572, filed on Feb. 22, 2008.

(51) Int. Cl. G08B 21/00; G05B 11/01

(52) U.S. Cl. 340/635; 340/310.11

(57) ABSTRACT

An LED street lamp including a PLC modem and a control circuit is disclosed. The LED street lamp is able to receive control commands from remote controller. It is also capable of doing self-control based on status information gathered by diagnostic circuit. A system for LED street lamp monitoring and control is also disclosed which includes a central controller, a distribution network and a plurality of LED street lamps. Based on the PLC technology, each LED street lamp can be centrally controlled by the central controller.

### CROSS-REFERENCE TO RELATED APPLICATION

This application claims benefit under 35 U.S.C. §119(e) of U.S. Provisional Application having Ser. No. 61/030,572 filed Feb. 22, 2008, which is hereby incorporated by reference herein in its entirety.

### FIELD OF INVENTION

The present invention relates to an apparatus and system for monitoring and controlling street lighting.

### BACKGROUND OF INVENTION

The street lamp is an important public facility in the city. On top of providing lighting for pedestrians, it also prevents criminals from committing crimes in dark.

Currently, the most commonly used street lamp is sodium vapor lamp, which has typical power consumption between 250 W and 400 W and a lifetime up to 5,000 hrs. It takes some delay to turn on or off the sodium vapor lamp. Another type of street lamp being used is mercury vapor lamp, which not only is detrimental to the environment but also requires a longer delay in turning on or off—as much as five minutes. There is therefore a need to continue to improve street lighting systems to make them more efficient and environmentally friendly.

### SUMMARY OF INVENTION

In the light of the foregoing background, provided is an alternative device and system for street illumination.

Accordingly, the present invention, in one aspect is a lighting apparatus for street illumination, which includes an LED light source, a control circuit which is connected to said LED light source, a power supply connected to power line and supplying electrical power to the LED light source and the control circuit, and a PLC transceiver electrically coupled to the control circuit and the power line. The control circuit controls electrical power supplied to the LED light source.

In one aspect of the present invention, a street lighting system includes a plurality of LED street lamps, each said LED street lamp contains an LED light source, a control circuit connected to said LED light source, and a PLC transceiver connected to the control circuit. Each LED street lamp is assigned with a unique identification code; and an electrical distribution network is electrically connected to and supplies electrical power to each LED street lamp. A central controller is connected to the electrical distribution network via a second PLC transceiver. The central controller controls and monitors the operation of each LED street lamp connected to the electrical distribution network by sending control commands to each street lamp and receives status information therefrom via the second PLC transceiver.

There are many advantages to the present invention, one of which is that the luminance of the LED street lamp can be adjusted or the LED street lamp can be switched on or off according to the ambient light. This is due to the intelligent control by the control circuit inside the LED street lamp, which can control the LED light according to information feedback from various sensors. The control circuit can also protect the LED light by reducing the current supplied to the LED light when there is an overheating situation detected by the diagnostic circuit inside the LED street lamp.

Another advantage provided by the present invention is the ability of centralized controlling of multiple LED street lamps via a PLC network. In one embodiment, all the LED street lamps are connected to the electrical distribution network via a PLC modem. A central controller which is also equipped with a PLC modem can then send various control commands to every LED street lamp via the electrical distribution network. This configuration provides huge convenience and saves lots of manpower for controlling and monitoring street lamps scattered over a large geographical area. The PLC network also enables additional functions such as security surveillance.

### BRIEF DESCRIPTION OF FIGURES

FIG. 1 is a block diagram of the apparatus of an LED street lamp in one embodiment.

FIG. 2 is a block diagram of the apparatus of an LED street lamp in another embodiment.

FIG. 3 is a structural diagram of an LED street lamp system in one embodiment.

FIG. 4 is a structural diagram of an LED street lamp system utilizing Internet in one embodiment.

FIG. 5 is a structural diagram of an LED street lamp system utilizing wireless communication in one embodiment.

FIG. 6 shows the use of an LED street lamp with cameras as a part of a surveillance system.

### DETAILED DESCRIPTION OF THE PREFERRED EMBODIMENTS

It is therefore an object of the present invention to provide an alternate street lamp monitoring and control system.

Recent advance in technology has produced high-power light emitted diode (LED) that is suitable for street lamps. An LED street lamp consumes only a quarter of the power of a traditional sodium vapor lamp. Moreover, it can last much longer—at least 50,000 hours. This reduces substantial amount of maintenance work in lamp replacement. Also, the time to turn on or off an LED lamp is significantly shorter than that of the sodium vapor lamp, not to mention the on/off delay of the mercury vapor lamp. The current invention recognizes that not only LED lamps are more energy efficient, but also their electronic mode of operation results in the ability to control lighting systems down to the individual lamp, resulting in much better control and efficiency if the necessary components are incorporated into the system as described below.

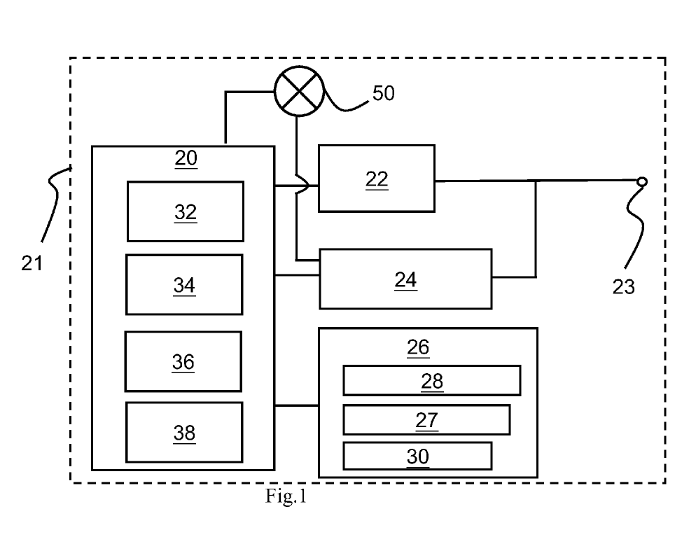

Referring now to FIG. 1, the first embodiment of the present invention is an LED street lamp with a self-diagnosis function and remote access capability. The LED street lamp comprises an LED light source 50, a control circuit 20, a power supply 24, a Power Line Communication (PLC) modem 22, a lamp socket 23 and a diagnostic circuit 26. The control circuit 20 connects to the other parts in the apparatus as a central control unit. The control circuit 20 comprises a microcontroller 32, a Read Only Memory (ROM) 34, a Random Access Memory (RAM) 36, and external ports 38, whose functions will be introduced later. The power supply 24 provides both the constant current for the LED light source 50, and the working voltage for the control circuit 20. Each street lamp is provided with a unique identification code so that it can be uniquely identified by a remote, central controller. In one embodiment, the unique identification code is stored in the ROM 34.

The PLC modem 22, which is a type of transceiver, enables the control circuit to connect to the PLC network. PLC is a data communication technology whereby the data is modulated onto the Alternative Current (AC) wave of the electrical power system. Hence, the power line not only supplies power to the equipments such as street lamp but also serves as a carrier for data transmission. The PLC modem 22 is the device that extracts from or injects data to the power line.

In the exemplary embodiment as shown in FIG. 1, both the electricity power and the data communication are linked to the distribution network via the lamp socket 23 when the LED street lamp 21 is mounted on a lamp pole. The diagnostic circuit 26, which comprises a current sensor 28 and a temperature sensor 30, monitors the operation of the LED light source 50 and provides a warning signal if an unusual condition is detected.

Now turning to the operation of the device described above. When the PLC modem 22 receives an incoming data packet sent by the central controller via the PLC network, the PLC modem 22 will first demodulate the data signal from the power line and send the information to the control circuit 20. In one embodiment, the data packet comprises at least one unique identification code of the street lamps, a command for the street lamp to execute, and optionally some parameters associated with that command. The control circuit 20 then examines the unique identification code. If this matches that of the street lamp, the control circuit 20 then executes the command. The command may be either to switch on the street lamp, to switch it off, or to modify its luminance to a value specified by the parameters. The control circuit 20 then controls the power supply 24 that supplies power to the LED light source 50. Meanwhile, the control circuit 20 of an individual street lamp 21 can also send status information together with its unique identification code via the PLC modem 22 back to the central controller, so that the central controller can monitor the well-being of each individual street lamp 21. In one embodiment, all the components, including the electronic parts mentioned above, of the LED light source 50 can be made to the same dimension of a conventional street lamp so that it can fit to the existing street lamp socket and housing. As such, by replacing existing street lamps with the LED street lamps 21, and by adding the computer server and the corresponding PLC modem at the server end, an operator can instantly control and monitor each individual street lamp within the network.

The power supply 24 provides electrical power to both the LED light source 50 and other circuits in the apparatus. In one embodiment, a Pulse Width Modulation (PWM) current source is used within the power supply 24 to provide PWM current to the LED. A special driving circuit that includes an inductor is also designed so that the driving current needs not drop to zero. By adjusting the pulse width in the PWM, the luminance of the LED lamp can vary accordingly. This arrangement saves significant power consumption compared to a pure DC power supply. It is found that even when the pulse width reduces greatly, the luminance only drops a small percentage. Moreover, the color change due to PWM power reduction can be contained in an acceptable range by properly controlling the PWM parameter. As the PWM driving circuit is embedded in each street lamp, each LED lamp can independently adjust its brightness. In an exemplary embodiment, the control circuit 20 adjusts the luminance by sending out control signal to the power supply 24 to adjust the pulse width of the supply current. The control circuit 20 can be programmed to do it independently, or it does so upon receiving a command from a central controller. This is a substantial advantage over existing street lamp system whereby an expensive and bulky controller is needed to install along the roadside to control a group of street lamps.

The diagnostic circuit 26 in the LED street lamp 21 monitors the operation of the LED light source 50, as well as other circuits/modules in the street lamp 21. In one embodiment, the diagnostic circuit 26 contains a luminance sensor 27, a current sensor 28 and a temperature sensor 30. The sensors in the diagnostic circuit 26 are used to detect the state element of the LED street lamp 21. Such state elements include but not limited to luminance, current or temperature. The luminance sensor 27 is a direct means for monitoring the luminance of the environment as well as the LED light source 50. The current sensor 28 monitors the current sent to the LED light source 50 to prevent it from over-supplying and burning the LED light source 50. The temperature sensor 30, on the other hand, monitors the overall temperature within the enclosure of the LED street lamp 21 and specifically the temperature of the LED light source 50. For example, when an LED street lamp 21 is accidentally covered by a blanket or similar material, the temperature sensor 30 in the diagnostic circuit 26 will detect that the temperature of the LED street lamp 21 is irregularly high. The diagnostic circuit 26 will then send a warning signal to the control circuit 20, which then send control signal to the power supply 24 to reduce the PWM current so as to protect the LED lamp from overheating. In this way, the street lamp itself can adjust the LED immediately without the intervention of a remote central controller. Thus, a potential failure can be discovered and avoided at the earliest time. The control circuit 20 may also report the abnormality to the central server so that a maintenance crew can be deployed to investigate. This self-diagnosis, self-rectifying and self-reporting feature can greatly relieve the burden of the maintenance unit and at the same time reduce the failure rate of the street lamps.

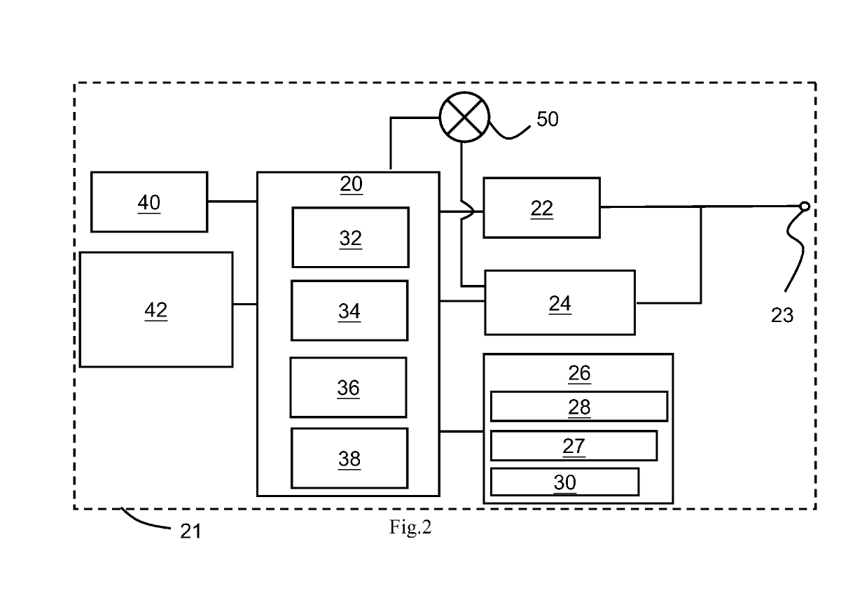

In one embodiment as shown in FIG. 2, the LED street lamp 21 further comprises various peripheral devices, which can communicate with external parties through the PLC network. For example, one or more cameras 40 may be installed on street lamp poles to monitor the real-time traffic on the road and send the captured information to a central system via the power line for further use. In addition, many types of environmental sensors 42 detecting atmosphere information such as sunlight radiation, temperature, humidity, air pressure, wind speed, wind direction, air quality, etc, may be installed in the LED street lamp 21 to provide environmental sensing ability to the street lamps. The sensor data can then be transmitted via the power line to a central server for further analysis.

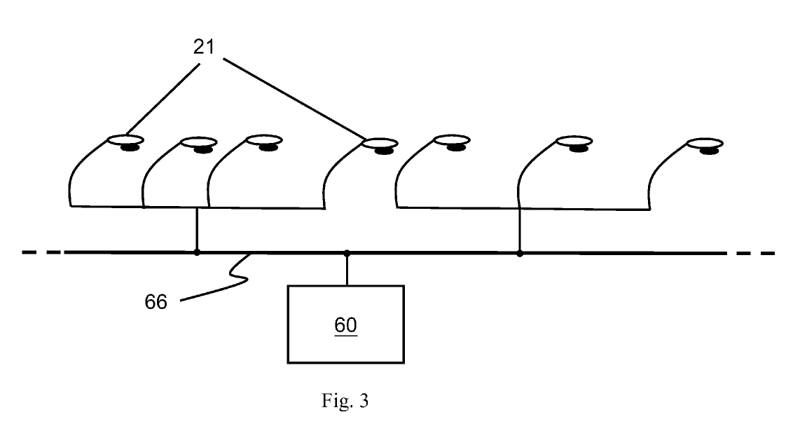

Turning now to FIG. 3, each LED street lamp 21 within the PLC network is connected to the electrical distribution network 66 which supplies electricity to street lamps. The structure of the PLC network is thus the same as the electrical distribution network 66. As mentioned earlier, each LED street lamp 21 is assigned with a unique identification code, which can be identified and individually communicated by the central controller 60. Using the PLC network, the central controller 60 is able to activate and control the luminance of each LED street lamp 21, or control multiple LED street lamps 21 at the same time. With this arrangement, street lamps along a street need not be turned on or off at the same time, but the brightness of each of them can be individually controlled to balance between sufficient luminance on the street and overall power saving. Furthermore, this embodiment takes an advantage of the power line infrastructure as the media for supplying power and transmitting data. There is no need to add additional hardware to the existing street lamp poles. Thus, the cost of establishing a centralized monitoring and control network is kept to minimum—a computer server that acts as a central controller and a PLC modem at the server end that serves as a bridge for data communication to individual street lamp 21. Yet the benefit of such a network is fully realized.

In an alternative embodiment, the LED street lamp 21 is able to operate in a stand-alone mode without the need of the central controller. In one embodiment, the LED street lamp 21 that is equipped with the luminance sensor 27 can switch itself on when the sensor detects that the ambient light is below a pre-determined threshold. Likewise, it can adjust its luminance according to the environment. For example, when the luminance sensor 27 detects that the ambient light is higher than another pre-determined threshold, the control circuit will set the LED street lamp 21 to dimming mode by adjusting the current supplied to the LED street lamp 21. This will save electrical power. In a further embodiment, while the street lamps 21 are networked together as mentioned before, each individual street lamp 21 can also operate on its own. Under normal circumstances, the street lamps 21 are under the control of the central controller. However, when the central controller 60 fails to operate, the individual street lamp 21 takes control to switch itself on or off, or adjust its luminance. This prevents the undesirable scenario that a single failure at the central controller or control point may cause the entire group of street lamps to become in-operative.

The street lamp system in the present invention has overcome the shortcoming of existing street lamp system, which is based upon manual inspection and replacement of individual street lamp. This manual procedure is labor intensive, time consuming and costly. For example, one approach to reduce the failure rate is to replace the street lamps before their life-expectance runs out. Though this premature replacement can reduce the failure rate, it leads to suboptimal use of street lamp resources. In the present invention, signs of potential failure in each street lamp can be individually detected, which reduces the need of the premature replacement procedure.

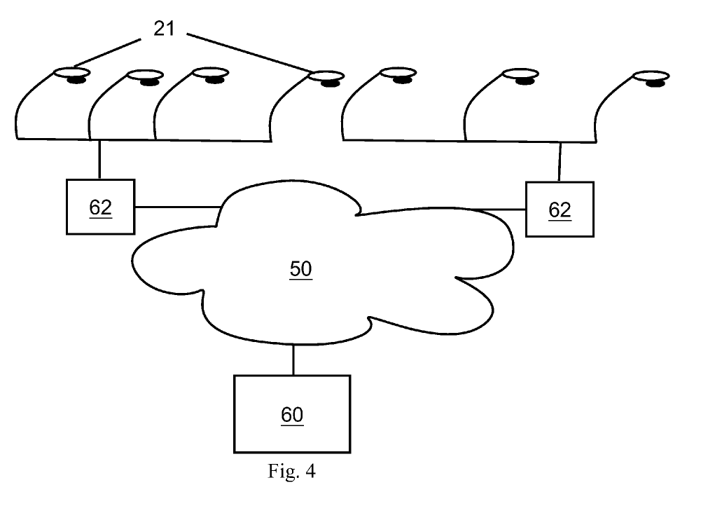

In one embodiment as shown in FIG. 4, each LED street lamp 21 is further connected to a PLC Internet gateway 62 while the central controller 60 is coupled to the Internet 52. The PLC Internet gateway 62 serves as a data communication bridge between the central controller 60 and the street lamps 21. This enables the central controller 60 to monitor and control street lamps across a wide metropolitan area, or even across different cities. The administration of street lamps can thus be focused and centralized by the aid of the Internet 52.

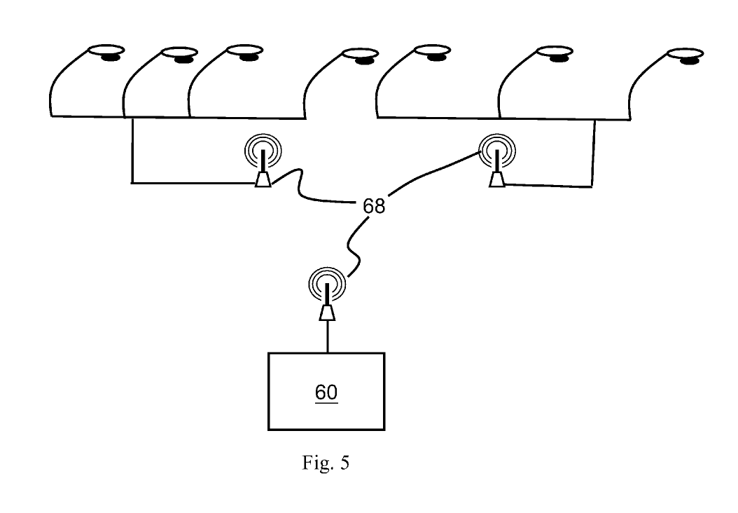

In another embodiment as shown in FIG. 5, one or more LED street lamps 21 are further connected to a wireless-to-PLC access point 68. Then, all the communications between the street lamps 21 and the central controller 60 will be carried on a wireless channel over the air. This configuration utilizes the wireless communication in lieu of the Internet 52. In yet another embodiment, each street lamp is equipped with a wireless module that can communicate to the central controller 60 either directly or through a public wireless network. The wireless technology can be, but not limited to, dedicated wireless radio, cellular network, Wireless Local Area Network (WLAN), or Bluetooth, ultra wide band (UWB), Zigbee, or WiMAX technologies.

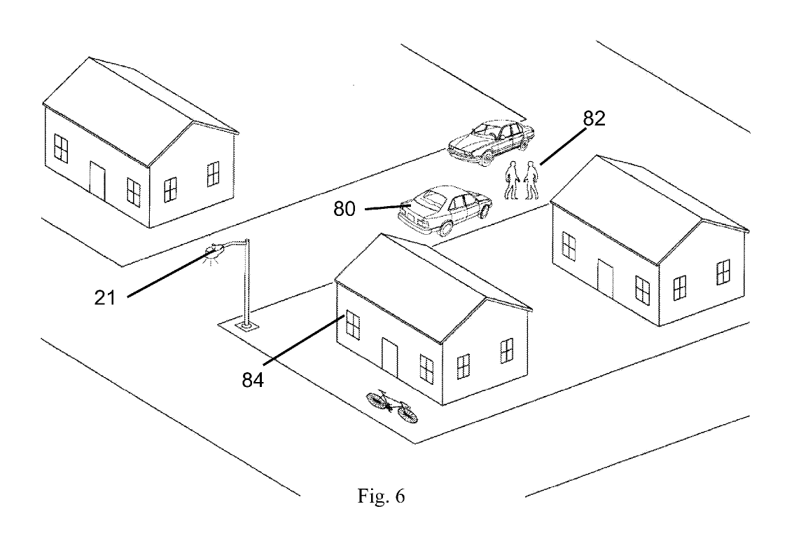

In the specific example shown in FIG. 6, a typical LED street lamp 21 in a residential area is equipped with at least one camera 40 which captures the snap-shot images or continuous video of the vehicles 80 and pedestrians 82 on the street. This configuration saves tremendous effort and costs in deploying separate cameras in the area to monitor traffic or a high secure zone where surveillance is needed. The captured image or video can be instantly sent to a remote control center via the PLC network. Likewise, a speed radar gun can also be installed on the street lamp pole to capture vehicles on a road that travel at a speed exceeding a pre-defined threshold, and then send relevant information to the police station via the PLC network.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

Although it is mentioned that the control circuit 20 comprises a microcontroller 32 with ROM 34 and RAM 36, it is clear to those skilled in the art that other technologies, such as an application-specific integrated circuit (ASIC) may be used instead. Moreover, the diagnostic circuit 26 may include not only the current sensor or temperature sensor but also circuitries to perform other diagnostic functions.

Though LEDs are used in the aforementioned embodiments to illustrate the inventive idea, other light-emitting technologies may also be used. For different lighting technologies, some or all components as shown in FIGS. 1 and 2 may need to be modified to adapt to the specific characteristics of that technology. Nonetheless, the inventive ideas mentioned in this disclosure can easily be extended to accommodate different lighting technologies by those skilled in the art, and hence they also fall in the scope of this disclosure.

1. A street lighting system comprising:
a) a plurality of Light Emitting Diode street lamps, each of said Light Emitting Diode street lamps comprising
i) a Light Emitting Diode light source;
ii) a control circuit connected to said Light Emitting Diode light source; and
iii) a first Power Line Communication transceiver electrically coupled to said control circuit;
wherein each of said Light Emitting Diode street lamps is assigned with a unique identification code;
b) an electrical distribution network that is electrically connected to and supplies electrical power to each of said Light Emitting Diode street lamps; and
c) a central controller connected to said electrical distribution network via a second Power Line Communication transceiver;
wherein said central controller controls and monitors operation of each of said Light Emitting Diode street lamps connected to said electrical distribution network by sending control commands to each of said street lamps and receives status information therefrom via said second Power Line Communication transceiver.

2. The street lighting system of claim 1, wherein each of said Light Emitting Diode street lamps further comprises a diagnostic circuit measuring status of said Light Emitting Diode light source and transmitting said status to said central controller via said electrical distribution network.

3. The street lighting system of claim 2, wherein said diagnostic circuit comprises at least one sensor, said sensor senses at least one status element, said status element includes but not limited to current, temperature or luminance; and said diagnostic circuit sends a warning signal to said control circuit when said sensor detects an irregular situation of said status element.

4. The street lighting system of claim 3, wherein said control circuit adjusts said electrical power supplied to said Light Emitting Diode light source when said luminance sensor detects that ambient light is deviated from a pre-determined threshold.

5. The street lighting system of claim 1, wherein each of said Light Emitting Diode street lamps further comprise a camera capturing street information on a street and sending said street information to said central controller via said electrical distribution network.

6. The street lighting system of claim 1, wherein each of said Light Emitting Diode street lamps further comprise a speed radar gun capturing vehicle on a road that travels at a speed exceeding a pre-defined threshold and sending information of said vehicle to said central controller via said electrical distribution network.

7. A lighting apparatus for street illumination, comprising:
a) a Light Emitting Diode light source;
b) a control circuit connected to said Light Emitting Diode light source;
c) a power supply connected to power line and supplying electrical power to said Light Emitting Diode light source and said control circuit; and
d) a Power Line Communication transceiver electrically coupled to said control circuit and said power line;
wherein said control circuit controls electrical power supplied to said Light Emitting Diode light source.

8. The lighting apparatus of claim 7 further comprising a diagnostic circuit measuring status of said Light Emitting Diode light source and transmitting said status to a remote system via said Power Line Communication transceiver.

9. The lighting apparatus of claim 8, wherein said diagnostic circuit comprises at least one sensor, said sensor senses at least one status element, said status element includes but not limited to current, temperature or luminance; and said diagnostic circuit sends a warning signal to said control circuit when said sensor detects an irregular situation of said status element.

10. The lighting apparatus of claim 9, wherein said at least one sensor is a luminance sensor, a current sensor or a temperature sensor.

11. The lighting apparatus of claim 10, wherein said control circuit adjusts said electrical power supplied to said Light Emitting Diode light source when said luminance sensor detects that ambient light is deviated from a pre-determined threshold.

12. The lighting apparatus of claim 9, wherein said control circuit controls said power supply to adjust current supplied to said Light Emitting Diode light source when said control circuit receives said warning signal from said diagnostic circuit.

13. The light apparatus of claim 12, wherein said power supply comprises a Pulse Width Modulation current source modulating the electrical current supplying to said Light Emitting Diode light source based on command received from said control circuit.

14. The lighting apparatus of claim 7 further comprising a camera, said camera capturing street information on a street and sending said street information to a remote system via said Power Line Communication transceiver.

15. The lighting apparatus of claim 7 further comprising environmental sensors, said environmental sensors capturing atmosphere information around said lighting apparatus and sending said atmosphere information to a remote system via said Power Line Communication transceiver.

16. The lighting apparatus of claim 7, wherein said lighting apparatus is assigned with a unique identification code.

17. A street lighting system comprising:
a) a plurality of Light Emitting Diode street lamps, each of said Light Emitting Diode street lamps comprising
i) a Light Emitting Diode light source;
ii) a control circuit connected to said Light Emitting Diode light source; and
iii) a Power Line Communication transceiver electrically coupled to said control circuit;
wherein each of said Light Emitting Diode street lamps is assigned with a unique identification code;
b) a communication network: wherein each of said Light Emitting Diode street lamps is connected to said communication network via a network gateway; and
c) a central controller connected to said communication network;
wherein said central controller controls and monitors operation of each of said Light Emitting Diode street lamps via said communication network.

18. The street lighting system of claim 17, wherein said communication network is the Internet; and said network gateway is a Power Line Communication Internet gateway.

19. The street lighting system of claim 17, wherein said communication network is a wireless network; and said network gateway is a wireless-to-Power Line Communication access point.
